(19) United States
(12) Patent Application Publication
(10) Pub. No.: US 2026/0154184 A1
(43) Pub. Date: Jun. 4, 2026

(54) SYSTEMS AND METHODS FOR TESTING OF SOFTWARE CODE

(71) Applicants: Constructor Technology AG, Schaffhausen (CH); Constructor Education and Research Genossenschaft, Schaffhausen (CH)

(72) Inventors: Roman FEDOROV, Sofia (BG); Serg BELL, Singapore (SG); Stanislav PROTASOV, Singapore (SG); Nikolay DOBROVOLSKIY, Alanya (TR); Laurent DEDENIS, Singapore (SG)

(21) Appl. No.: 18/964,758

(22) Filed: Dec. 2, 2024

(51) Int. Cl. G06F 11/3668

(52) U.S. Cl. CPC G06F 11/3684; G06F 11/368; G06F 11/3688

(57) ABSTRACT

Disclosed herein are systems and method for a snapshot based testing of software code. In one aspect, a method includes: receiving a first snapshot of an executed software code; receiving a second snapshot of the executed software code; comparing the first and second snapshots to identify static and/or dynamic parameters, wherein the static parameters have the same input and output values in both the first and second snapshots, and dynamic parameters have the same input values and different output values in each snapshot; analyzing the executed software code to determine relationships between the dynamic parameters and to identify related dynamic parameters; generating a test for testing the software code; receiving a modification to the software code; and applying the generated test to the executed modified software code.

### FIELD OF TECHNOLOGY

The present disclosure relates to the field of software code testing, and, more specifically, to systems and methods for a snapshot-based testing of software code.

### BACKGROUND

Checking differences between test runs of executed software code is a critical practice in information technologies for several reasons. First, by comparing test runs, developers can identify unexpected changes in behavior, which may indicate bugs or regressions. Second, differences between test runs provide a clear record of what has changed. In this way, better communication and collaboration may be facilitated among test members. By continuously comparing test rungs and applying validation rules, issues can be detected early in the development process, reducing the cost and effort required to fix them. The differences between test runs provide a historical record of changes, which is useful for both documentation and compliance purposes. In this way, checking differences between test runs ensures software quality, improves efficiency, enables early detection of issues, and provides scalability. These practices ultimately lead to more robust, reliable, and maintainable software systems.

However, testing and checking difference between test runs of executed code may be challenging for several reasons. These challenges may stem from the complexity of the software, the environment in which the tests are being run, and the tools and/or methodologies used. In addition, values in test runs may are almost always considered dynamic and the results from the test run should be evaluated or compared with tools. For example, fields such as updated_date or ID are considered dynamic parameters because the values in these fields change on each test run. Furthermore, manual steps in the testing process may introduce variability and errors.

### SUMMARY

To address the shortcomings of preparing and reviewing conventional post-race analysis, the present disclosure describes utilizing machine learning-based testing of software code by automatically generating validating tests. Some of the technical improvements of the present disclosure are reducing the risk of human error and increasing reliability of test results by automating validating rules, efficiency and automation of testing, improving test coverage and accuracy, scalability, and documentation and compliance of executed test runs. Yet another technical improvement of the present disclosure is ensuring software quality, facilitating collaboration among team members, and enabling early detection of issues.

In one exemplary aspect, a method for snapshot-based testing of software code is described, the method comprising: receiving a first snapshot of an executed software code, wherein the first snapshot identifies a plurality of input and output parameters and corresponding values for each parameter; receiving a second snapshot of the executed software code, wherein the second snapshot includes a plurality of input and output parameters and corresponding values for each parameter; comparing the first and second snapshots to identify static and/or dynamic parameters, wherein the static parameters have the same input and output values in both the first and second snapshots, and dynamic parameters have the same input values and different output values in each snapshot; analyzing the executed software code using to determine relationships between the dynamic parameters and to identify related dynamic parameters; generating a test for testing the software code, wherein the test comprises a plurality of test rules comparing the values of static parameters and/or comparing the values of related dynamic parameters in each snapshot and/or between the first and second snapshots; receiving a modification to the software code; and applying the generated test to the executed modified software code to compare, using the plurality of test rules, the input and output values of the static parameters or input and/or output values of the related dynamic parameters of the modified executed software code with values of the corresponding parameters of the first and second snapshots to identify errors in the modified executed software code.

In one aspect, the method further comprises: executing the software code on a set of input parameters to generate the first snapshot; executing the software code on a similar test to generate the second snapshot, wherein the similar test corresponds to the generated test with a subset of new input parameters; and executing the modified executed software code on the same set of input parameters.

In one aspect, the method further comprises executing the software code on the same set of input parameters to generate the second snapshot.

In one aspect, the analyzing the executed software code further comprises using a trained ML model to determine relationships between the dynamic parameters and to identify related parameters.

In one aspect, the method further comprises executing the software code using the trained ML model to identify the plurality of parameters and the corresponding input and output values for each parameter.

In one aspect, comparing the first and second snapshots further comprises: executing the software code using the trained ML model to identify relationships between the related dynamic parameters.

In one aspect, the method further comprises training the ML model using training datasets comprising snapshots from other tests of the same executed software code to determine relationships between the dynamic parameters and to identify related dynamic parameters.

In one aspect, the plurality of test rules comprises at least one of: determining whether a value exists for each static parameter or each related dynamic parameter, determining a value type for each static parameter or each related dynamic parameter, determining static values for each static parameters, or determining relationship for each dynamic parameter.

In one aspect, the method further comprises: storing the input and output values of the static parameters or input and/or output values of the related dynamic parameters of the modified executed software code with values of the corresponding parameters of the first and second snapshots as a final snapshot.

In one aspect, the method further comprises: receiving a new snapshot of the modified executed software code, wherein the new snapshot identifies a plurality of parameters and corresponding input and output values for each parameter; and based on a determination that the identified parameters are static parameters, comparing, using the plurality of test rules, the input and/or output values of the static parameters of the modified executed software code with values of the corresponding parameters of the final snapshot to identify errors in the modified executed software code.

In one aspect, the method further comprises: receiving a new snapshot of the modified executed software code, wherein the new snapshot identifies a plurality of parameters and corresponding input and output values for each parameter; and based on a determination that the identified parameters are dynamic parameters, comparing, using the plurality of test rules, the output values of the related dynamic parameters of the modified executed software code with values of the corresponding parameters of the final snapshot to identify errors in the modified executed software code.

In one aspect, the static and dynamic parameters correspond to at least one of variables, functions, form fields, or file paths.

According to one aspect of the disclosure, a system is provided for snapshot-based testing of software code, the system comprising at least one memory; and at least one hardware processor coupled with the at least one memory and configured, individually or in combination to: receive a first snapshot of an executed software code, wherein the first snapshot identifies a plurality of input and output parameters and corresponding values for each parameter; receive a second snapshot of the executed software code, wherein the second snapshot includes a plurality of input and output parameters and corresponding values for each parameter; compare the first and second snapshots to identify static and/or dynamic parameters, wherein the static parameters have the same input and output values in both the first and second snapshots, and dynamic parameters have the same input values and different output values in each snapshot; analyze the executed software code using a trained ML model to determine relationships between the dynamic parameters and to identify related dynamic parameters; generate a test for testing the software code, wherein the test comprises a plurality of test rules comparing the values of static parameters and/or comparing the values of related dynamic parameters in each snapshot and/or between the first and second snapshots; receive a modification to the software code; and apply the generated test to the executed modified software code to compare, using the plurality of test rules, the input and output values of the static parameters or input and/or output values of the related dynamic parameters of the modified executed software code with values of the corresponding parameters of the first and second snapshots to identify errors in the modified executed software code.

In one exemplary aspect, a non-transitory computer-readable medium is provided storing a set of instructions thereon for snapshot-based testing of software code, wherein the set of instructions comprises instructions for: receiving a first snapshot of an executed software code, wherein the first snapshot identifies a plurality of parameters and corresponding input and output values for each parameter; receiving a second snapshot of the executed software code, wherein the second snapshot includes a plurality of parameters and corresponding input and output values for each parameter; comparing the first and second snapshots to identify static and/or dynamic parameters, wherein the static parameters have the same input and output values in both the first and second snapshots, and dynamic parameters have the same input values and different output values in each snapshot; analyzing the executed software code to determine relationships between the dynamic parameters and to identify related dynamic parameters; generating a test for testing the software code, wherein the test comprises a plurality of test rules comparing the values of static parameters and/or comparing the values of related dynamic parameters in each snapshot and/or between the first and second snapshots; receiving a modification to the software code; and applying the generated test to the executed modified software code to compare, using the plurality of test rules, the input and output values of the static parameters or input and/or output values of the related dynamic parameters of the modified executed software code with values of the corresponding parameters of the first and second snapshots to identify errors in the modified executed software code.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for machine learning (ML) based testing of software code according to aspects of the present disclosure.

FIG. 2 is a block diagram of a machine learning training pipeline according to aspects of the present disclosure.

FIG. 3 is a flow diagram of a method for training and executing tests after modifying software code according to aspects of the present disclosure.

FIG. 4A is a diagram illustrating an example of a snapshot of a first test run according to aspects of the present disclosure.

FIG. 4B is a diagram illustrating an example of a snapshot of a second test run according to aspects of the present disclosure.

FIG. 4C is a diagram illustrating an example of a snapshot of a third test run according to aspects of the present disclosure.

FIG. 5 is a flow diagram of a method for a snapshot-based testing of software code according to aspects of the present disclosure.

FIG. 6 presents an example of a general-purpose computer system on which aspects of the present disclosure can be implemented.

Like reference numbers and designations in the various drawings indicate like elements.

### DETAILED DESCRIPTION

Exemplary aspects are described herein in the context of a system, method, and computer program product for machine learning (ML)-based testing of software code. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The present disclosure describes various aspects of ML-based testing of software code by checking for differences between test runs and automatically generating validating rules for the test. One aspect involves analyzing software code to identify all parameters and corresponding values for the purpose of testing the software and saving the results into snapshots. A second aspect involves generating a test for testing the product where the test includes a list of parameters to be tested and corresponding values (where applicable). The third aspect involves designating inputs and output parameters for each parameter.

Input and output parameters are essential components of functions and methods in software development. Input and output parameters enable data to be passed into and out of functions of software code, facilitate modularity, flexibility, and encapsulations. The parameters allow functions to be modular and reusable, enabling code to be broken down into smaller, manageable pieces. By passing different values as input parameters, the same function can perform a variety of task. Parameters also help encapsulate the function's logic, making the code easier to understand and maintain. Input and output parameters make it easier to test functions by providing clear points of interaction.

Monitoring the inputs and output differences between test runs of executed software code is crucial to ensure the quality, reliability, and maintainability of the software. There are several reasons why this is important. First, monitoring the differences between test runs helps identify when new changes break existing functionality and ensures that the software remains stable and reliable over time. In addition, monitoring the differences also ensures that tests produce consistent results across different runs, which may be essential for reproducibility. Third, comprehensive testing helps ensure that all aspects of the software are tested including edge cases and unusual scenarios. Fourth, checking the differences in inputs and outputs can help pinpoint the root cause of issues, making it easier to debug and fix problems. Furthermore, in continuous integration and deployment (CI/CD) pipelines, automated tests can quickly identify differences between test runs, ensuring that new code does not introduce issues. In large and complex codebases, monitoring differences helps manage the complexity and ensures that changes do not have unintended side effects. This helps developers understand the interdependencies between different parts of the code and how changes affect them.

As a non-limiting example, a development team may be working on a financial application. During the development phase, the developers may run automated tests to ensure the accuracy of financial calculations. By monitoring the input and outputs of these tests, the development team may detect regressions to identify when a new change introduces an error in the calculations, ensure consistency to verify that the calculations produce consistent results across different runs, facilitate debugging to quickly pinpoint the root cause of any discrepancies in the calculations, and support compliance.

Turning now to the figures, example aspects are depicted with reference to one or more components described herein, where components in dashed lines may be optional.

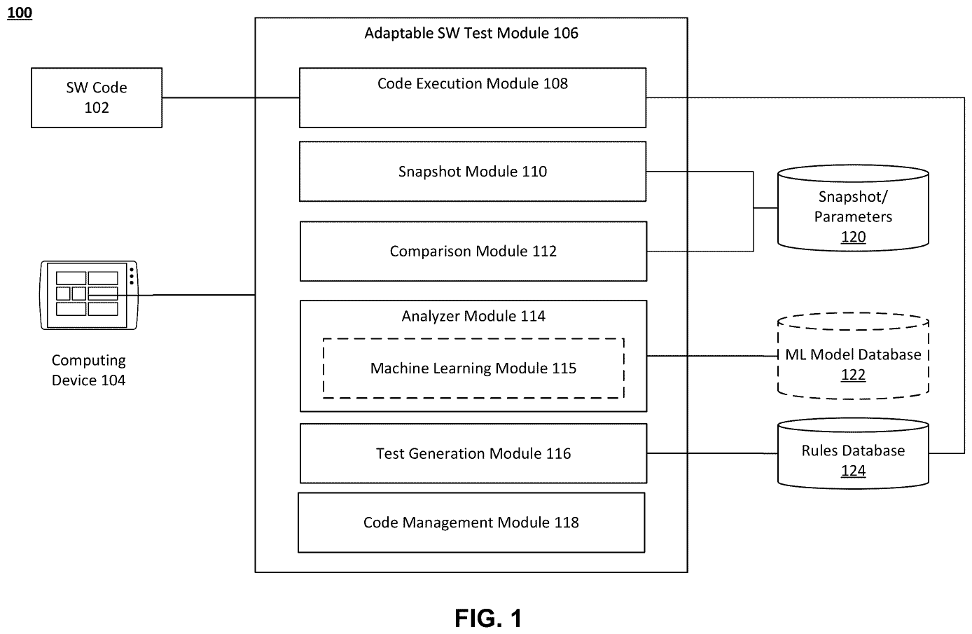

FIG. 1 is a block diagram illustrating a system 100 for machine-learning based testing of software code. The system 100 may be used to check differences between test runs of software code 102 and automatically generate validating rules for a test by identifying static and/or dynamic parameters using an adaptable SW test module 106. Specifically, the adaptable SW test module 106 is configured to monitor input and outputs of artifact difference between test runs of executable software code 102.

In some aspects, the adaptable SW test module 106 is configured to automatically analyze a software product using an AI model to identify all parameters and corresponding values for the purpose of testing the software code 102. In some aspects, the adaptable SW test module 106 is further configured to generate a test for testing the software code 102. In some aspects, the test comprises a plurality of test rules comparing the values of static parameters and/or comparing the values of related dynamic parameters in each snapshot and/or between the first and second snapshots. In some aspects, the adaptable SW test module 106 is also configured to designate input and output values for each parameter. The computing device 104 may communicate with the adaptable SW test module 106.

The system 100 includes software code 102, computing device 104, the adaptable SW test module 106, a snapshot/parameter database 120, a ML model database 122, and a rules database 124. As a non-limiting example, the input parameters for the testing may include static parameters and/or dynamic parameters. In addition, the parameters may include at least variables, functions, or fields. Each of the parameters may have a corresponding value that is either predefined in the code or automatically generated by an analyzer software for the purpose of testing the software.

In software development, input and output parameters are fundamental concepts that define how data is passed into and out of functions, methods, or procedures of software code. Understanding these parameters is crucial for designing and implementing effective and reusable code.

Specifically, input parameters are the values or variables that are passed to a function or method when it is called. These parameters provide the necessary data for the function to perform its task. The input parameters may be specified in the function's signature or definition. In some cases, depending on the programming language, input parameters can be passed by value (a copy of the data) or by references (a reference to the actual data). Functions may also accept multiple input parameters when they are separated by commas.

Output parameters are the values or variables that a function or method returns after execution. These parameters provide the result of the function's computation or operation. The output parameters are typically specified using a return statement. Depending on the language, a function may return a single value or multiple values. In addition, some functions may not return any value (void functions).

As shown in FIG. 1, the system 100 may also include a computing device 104 may communicate with the adaptable SW test module 106. The computing device 104 allows for a user to control and configure the system 100 and also view results from the testing. Computing device 104 may execute a plurality of modules in the adaptable SW test module 106 that together make up an identification, analysis, and testing system. In some aspects, the adaptable SW test module 106 may correspond to a computing device 104 or cloud network that is configured to execute a plurality of modules that together make up the adaptable SW test module 106. The adaptable SW test module 106 may obtain one or more software code 102 for testing (or validation) in order to check the difference between tests runs of the software code 102 and generate validating rules for the test.

In some aspects, the adaptable SW test module 106 may include a code execution module 108, a snapshot module 110, a comparison module 112, an analyzer module 114, a test generation module 116, and a code management module 118.

The computing device 104 may execute the code execution module 108 to execute the one or more software code 102. The computing device 104 may be configured to execute the one or more software code for a first time using a trained ML code analysis model. In some aspects, the computing device 104 may be configured to execute the code execution module 108 using a set of input parameters to generate one or more snapshots. In some examples, the computing device 104 may be configured to execute the code execution module 108 using a trained ML model.

The computing device 104 may also execute a snapshot module 110 to generate snapshots of the software code executed on a set of input parameters. Snapshots are a way to capture the output or state of an application at a specific point in time. These are often used in testing to ensure that the output of a function or component remains consistent over time. Specifically, snapshot testing is a technique used to verify the output of a piece of software code 102 by comparing it to a previously recorded “snapshot” of the output. If the current output matches the snapshot, the test passes, otherwise if the output changes unexpectedly, the test will fail which indicates a potential issue.

In some examples, the information regarding detected changes between test runs, which changes are dynamic are saved into snapshots. In some examples, the snapshot may be saved as YAML Ain't Markup Language (YAML). YAML is a human-readable data serialization standard that is commonly used for configuration files and data exchange between with different data structures. In the context of software testing, YAML files are often used for storing test configurations, test data, and snapshots due to its simplicity and readability. In some aspects, YAML files can be used for storing configuration settings for tests, providing input data for tests, and storing snapshots of the output or state of the application at a specific point in time.

In some examples, the snapshots are “near test,” which refers to the practice of storing snapshot files close to the test files that generate them. This approach is often used in snapshot testing frameworks to keep the test code and its associated snapshots organized and easily accessible. By keeping snapshots near their tests, developers can quickly locate and understand the context of the snapshots, leading to more effective and efficient testing.

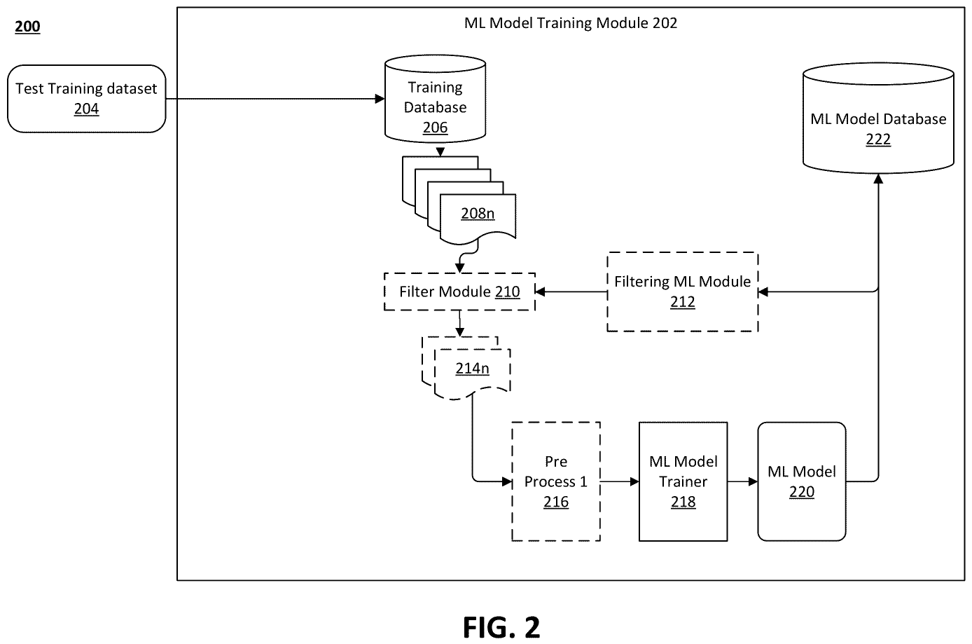

In some aspects, the snapshots contain information for identifying a plurality of parameters and corresponding input and output values for each parameter and stores this information in a snapshot/parameter database 120. Examples of snapshots will be described in more detail in FIGS. 2A-2C.

The computing device 104 may also execute a comparison module 112 to compare the first and second snapshots to identify static and/or dynamic parameters from the snapshot/parameter database 120. As mentioned above, in software testing, parameters are used to define the input and conditions under which tests are executed. Parameters can be categorized as static parameters or dynamic parameters.

Static parameters are fixed values that do not change during the execution of a test. They are predefined and remain constant throughout the test run. Static parameters are typically used when the input values are known in advance and do not need to be modified based on the test context or environment. As an example, in a unit test for a function that calculates the sum of two numbers, the input and output values can be static parameters. Static parameters provide consistency and simplicity, making them ideal for regression and unit testing.

Dynamic parameters are values that can change during the execution of a test. These parameters are often generated or modified based on the test context, environment, or other conditions. Dynamic parameters are useful when the input values need to be flexible and adaptable to different scenarios. In other words, in a test for a function that processes user input, the input values can be dynamically generated based on different user scenarios. Dynamic parameters offer flexibility and adaptability, making them suitable for exploratory, performance, and integration testing. As an example, for a function designed to return a current date and time, the input may be static whereas the output is dynamic.

The computing device 104 may also execute an analyzer module 114 that may comprise at least a machine learning module 115 to analyze the executed software code 102 using a trained ML model. In some examples, the analyzer module 114 may use a simple comparison or statistical method for determining correlations between dynamic parameters. In some examples, the trained ML model in the machine learning module 115 is trained to determine relationships between the dynamic parameters and to identify related dynamic parameters. In some examples, the system 100 may detect correlation between dynamic parameters by exact comparison. In some examples, the system 100 detect correlation between dynamic parameters using neural network. In some examples, the software code may be executed using the trained ML model to identify relationships between the related dynamic parameters.

In some examples, the machine learning module 115 may comprise one or more neural networks, which are a class of machine learning models inspired by the structure and functioning of the human brain. They consist of interconnected nodes, called neurons or artificial neurons, organized into layers. Neural networks are capable of learning complex patterns and representations from data. The neural network executed by the machine learning module 115 may be one of the following: transformer neural network, convolution neural network (CNN), recurrent neural network (RNN), long short-term memory (LSTM) network, gated recurrent unit (GRU) network, autoencoder, generative adversarial network (GAN).

A transformer is a deep learning architecture used in large language models (LLMs). The transformer has an encoder/decoder structure with numerous stacked multi-head attention layers and feed forward network layers. This architecture allows the model to process and generate text effectively, capturing long-range dependencies and contextual information. Transformer are well-suited for tasks like natural language processing, and image classification and generation. Common examples of transformer models are generative pre-trained transformer (GPT) and Bidirectional Encoder Representations from Transformers (BERT).

For tasks such as detecting correlations between dynamic parameters, an untrained neural network in the machine learning module 115 may be trained by using training dataset comprising snapshot from other tests of the same executed software code to determine relationships between the dynamic parameters and to identify related dynamic parameters. Accordingly, since the machine learning module 115 may be designed to detect correlations between dynamic parameters, then the training data may need samples from different test runs of a similar test. The similar test corresponds to the generated test but with a partial new set of input parameters because some parameters are dynamic and renew in each test run. In some examples, the trained ML models may be stored in a ML model database 122.

During training of the neural network in the machine learning module 115, the training dataset comprises snapshots from either the same test and/or other tests of the same executed software code that are input through an untrained neural network in the machine learning module 115. The results from the untrained neural network are then compared with known data set results using the corresponding labels identifying related dynamic parameters.

For every input training sample from the training dataset, the neural network from the machine learning module 115 will produce a prediction consisting of values representing the probability that the dynamic parameters are related. The output with the highest probability determines the correlation between dynamic parameters.

In some examples, the machine learning module 115 may store the input and output values of the static parameters or input and/or output values of the related dynamic parameters of a modified executed software code with values of the corresponding parameters of the first and second snapshots as a final snapshot.

The machine learning module 115 may then use a loss function that quantifies the error between the predicted output and the ground truth (e.g., labeled data) for a given training sample. In other words, the loss function can be used to guide the learning process by updating the network weights in a way that improves the accuracy of future predictions. This process may continue until the difference between the predictions and the correct targets is minimal.

Once a neural network is trained (e.g., inference), the machine learning module 115 may determine relationships between the dynamic parameters and identify related dynamic parameters. Specifically, the machine learning module 115 contains a trained neural network configured to determine relationships between the dynamic parameters and identify related dynamic parameters.

During inference, the trained neural network racer from the machine learning module 115 does not re-evaluate or adjust the layers of the neural network based on the results. Instead, the inference applies knowledge from the trained neural network and uses it to infer a result. Accordingly, when a new unknown dataset (e.g., new parameters) is input through the trained neural network in the machine learning module 115, the trained neural network outputs a prediction of related dynamic parameters and identified related dynamic parameters.

The computing device 104 may also execute a test generation module 116 to generate a test for testing the software code 102. In some aspects, the test may include a list of parameters (e.g., variables, functions, or fields) to be tested and corresponding values where applicable. In some aspects, the test comprises a plurality of test rules comparing the values of static parameters and/or comparing the values of related parameters in each snapshot and/or between the first and second snapshots. In some aspects, wherein the plurality of test rules comprises at least one of: determining whether a value exists for each static parameter or each related dynamic parameter, determining a value type for each static parameter or each related dynamic parameter, determining static values for each static parameters, or determining relationship for each dynamic parameter. In some aspects, the generated test is stored in the rules database 124. The generated test may automatically validate input and output artifacts. As a non-limiting examples the input and/or output artifacts may include a network input (e.g., http: header, body), network output (e.g., http), database query test (e.g., Postgres), database parameters and values, file system path (e.g., if any files/folders are created in specific paths), or custom (e.g., third party artifacts, new files in Sharepoint storage, etc.).

The computing device 104 may also execute a code management module 118 to receive a modification to the source code through the computing device 104.

After the code is modified, then the computing device may execute the code execution module 108 to apply the generated test from the rules database 124 to the executed modified software to compare the input and output values of the static parameters or input and/or output values of the related dynamic parameters of the modified executed software code with values of the corresponding parameters of the first and second snapshots to identify errors in the modified executed software code.

FIG. 2 is a block diagram illustrating machine learning training pipeline according to aspects of the present disclosure. As shown in the example 200 as shown in FIG. 2, a ML training module 202 is configured to build and train a specialized machine learning model 220 with inference to analyze executed software code to determine relationships between the dynamic parameters and to identify related dynamic parameters. This enables the specialized machine learning model 220 to develop an ability to determine relationships between the dynamic parameters and to identify related dynamic parameters within new software code that is not part of a training dataset. By subjecting the specialized machine learning model 220 to large amounts of labeled trained data sets, the specialized machine learning model 220 may detect and identify relationships between the dynamic parameters and to identify related dynamic parameters based on supervised learning.

Supervised learning is effective for tasks such as classification (assigning inputs to predefined categories) and regression (predicting continuous values) since it relies on the availability of labeled data for both training and evaluation phases. In supervised learning, the ML training module 212 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. In the training phase, the ML training module 212 provides the algorithm with a training dataset including input-output pairs. The algorithm learns the mapping function that relates inputs to outputs through an iterative process, adjusting its internal parameters based on the provided examples. During model building, the algorithm creates a model that can generalize from the training data to make predictions on new, unseen data. The model's complexity varies based on the algorithm used. For example, the model may be a simple linear regression model or a complex neural network. During the prediction phase, the ML training module 212 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, the ML training module 212 refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

In some aspects, the ML training module 202 contains at least a training database 206 configured to store the raw test training data 204, a ML model database 222 to store the trained model 220, a ML model trainer 218, and an optional filter module 210 configured to filter data from the training database 206 for training by removing bad training data.

Test training data 204 may include other snapshots from other tests of a same product or from the same tests. In some aspects, the test training data 204 is received into the ML training module 202. In some aspects, the test training dataset 204 may include a static parameters dataset and/or a dynamic parameters dataset, and corresponding labels identifying the parameters and/or relationships between the dynamic parameters.

An optional filter module 210 is configured to filter out bad training images in order to claim up the training data in the training dataset 208n. In some examples, the filter module 210 may be a neural network. In some examples, the filter module 210 is a simple mathematical model. In some examples, the cleaned training dataset 214n then undergoes optional preprocessing steps depending on which neural network or model is being trained.

The optional preprocess 216 are automated processes that modify the raw data received from 208n (or cleaned training dataset 214n) and prepare the raw data as input to a ML model trainer 218. These may be described in the ML training module 202 as snippets of code that prepares the datasets. In some examples, the preprocessing module for a particular trainer may be an automated script or code that will be setup the first time any model is trained.

The ML model trainer 218 is a script or code that trains the model. The ML model trainer 218 may be a script or code that holds the instructions on how a model should be trained (e.g., optimization method, model architecture, dataset division, etc.) and also runs the training. The ML model trainer 218 takes as input the raw or filtered processed training data and train the ML model 220 to achieve its specific objectives of determining relationships between the dynamic parameters and identifying related dynamic parameter.

As explained above in the machine learning module 115 from FIG. 1, a neural network is essentially a complex mathematical function. The neural network models are designed using a set of hyperparameters that define high-level aspects of their architecture and training process. These hyperparameters include, but are not limited to a combination of architecture type, number of layers, memory size, number of attention heads, learning rate, batch size, optimization algorithm, and the like. Based on these hyperparameters, learnable variables called parameters are initialized, which define the mathematical function that the neural network represents.

The raw training dataset 208n used for training may contain noise and bad training images from the training database 206. Accordingly, to create a clean and filtered training dataset, the optional filter module 210 is configured to filter out unwanted data points from the raw training dataset 208n by developing smaller, less accurate systems based on patterns and metadata information. The resulting training dataset 214 may consist of parameters and labels, where each parameter is labeled with a corresponding label indicating the name of the parameter, related parameters, and/or relationships to other dynamic parameters.

During the training process, the ML model trainer 218 (e.g., neural network) is presented with images and labels, and the optimization objective, which aims to minimize the difference between the actual value and the predicted value, is calculated. The optimization algorithm updates the parameters of the ML model trainer 218 to reduce the value of the objective. This process is repeated for several iterations until the parameters do not change anymore. This process is repeated for various combinations of hyperparameters, and the model with the smallest label prediction error is selected as the final model.

When a new model (e.g., a trained ML model 220) is created, and a new process for filtering and automated labeling is established, it is added to the ML model database 222 in the ML training module 202. This enables the new model to be part of the closed-loop model update process. Optionally, at regular intervals, data which is continuously collected can be filtered, labeled, and used to update old models by an optional filtering ML module 212. In some examples, the filtering ML module 212 is a neural network. In some examples, the filtering ML module 212 is a simple mathematical model. This approach may capture changes in the appearance of racers and/or unique geolocations over time. However, if the visual appearances of the racers and/or geolocations remain consistent, the existing large-scale data should be sufficient, and new data may not bring significant additional information.

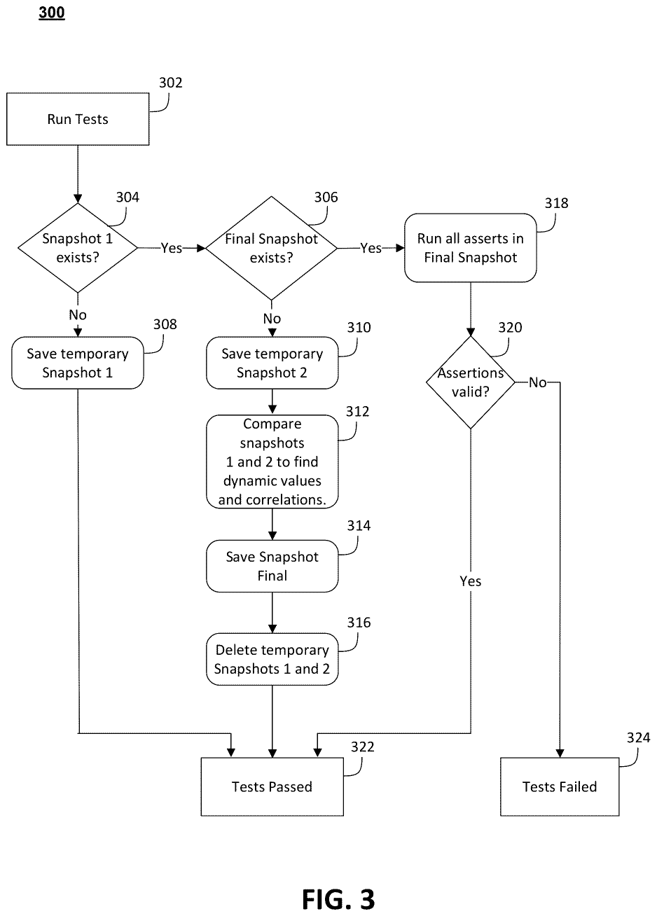

FIG. 3 is a flow diagram of a method for training and executing tests after modifying software code according to aspects of the present disclosure. In various implementations, the method 300 is performed by a device with one or more processors and non-transitory memory that performs intent prediction. In some implementations, the method 300 is performed by processing logic, including hardware, firmware, software, or a combination thereof. In some implementations, the method 300 is performed by a processor executing code stored in a non-transitory computer-readable medium (e.g., a memory). The method 300 describes learning the parameters in the code using a first and second snapshot to identify which parameters are static and which are dynamic and then performing the test on a final snapshot.

At 302, the method 300 includes running the tests. As an example, referring back to FIG. 1, the code execution module 108 may run a test obtained from the rules database 124. In some aspects, the software code is run for the first time. In some aspects, the software may be run for the first time using a trained AI code analysis model.

At 304, the method 300 includes determining whether a first snapshot exists. If it is determined that a snapshot exists, then, at 306, the method 300 includes determining whether a final snapshot exists. If it is determined that the snapshot does not exist, then, at 308, the method 300 includes saving a first temporary snapshot and, at 322, the method 300 includes the test passes. In some aspects, the first temporary snapshot may be stored at a snapshot/parameter database 120.

If it is determined that a final snapshot does not exist, then, at 310, the method 300 includes saving a second temporary snapshot. In some aspects, the second temporary snapshot may be stored at a snapshot/parameter database 120.

At 312, the method 300 then includes comparing the first and second snapshots to find dynamic values and correlations. As an example, referring back to FIG. 1, the comparison module 112 may detect differences between the first and second snapshots and mark the differences as dynamic parameters (e.g., IDs, datetime, duration, etc.). In some aspects, the method 300 may detect correlation between dynamic parameters by a simple comparison or statistical correlation method. In some aspects, the method 300 may detect correlation between dynamic parameters by using a neural network (e.g., machine learning module 115). As an example, referring back to FIG. 2, the neural network can be trained using other snapshots form other tests of the same product.

At 314, the method 300 includes saving a final snapshot of the dynamic values and correlations. In some aspects, the second temporary snapshot may be stored at a snapshot/parameter database 120.

At 316, the method 300 includes deleting temporary first and second snapshots and, at 322, the test passed. As an example, referring back to FIG. 1, the snapshot module 110 may delete the temporary first and second snapshots from the snapshot/parameter database 120.

If it is determined that the final snapshot exists, then, at 318, the method 300 includes running all asserts in the final snapshot. As an example, referring back to FIG. 1, the code execution module 108 may run all asserts from the final snapshot.

At 320, the method 300 includes determining whether assertions are valid. If it is determined that the assertions are not valid, then, at 324, the method 300 includes the test failed. If it is determined that the assertions are valid, then, at 322, the method includes the test passed.

As an aspect, the method 300 may include modifying the software code. The test is run on the modified code. The method 300 then automatically generates and runs asserts. In some examples, the method 300 may generate 3-400+ asserts. As a non-limiting example, the asserts may include the value exists, the value type, static value (e.g., which should be tested using same test values of parameter), or dynamic values with correlation. The method 300 may include running all generated assertions. If any assertions fail, then the test is considered failed.

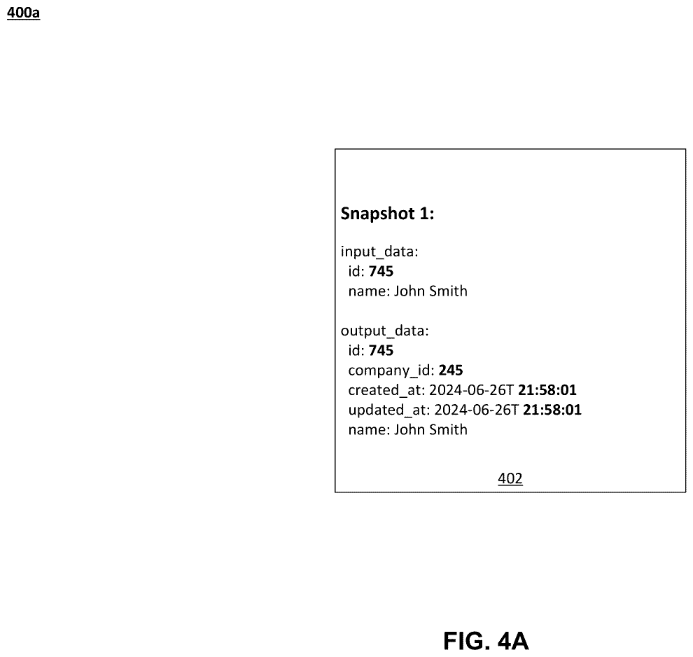

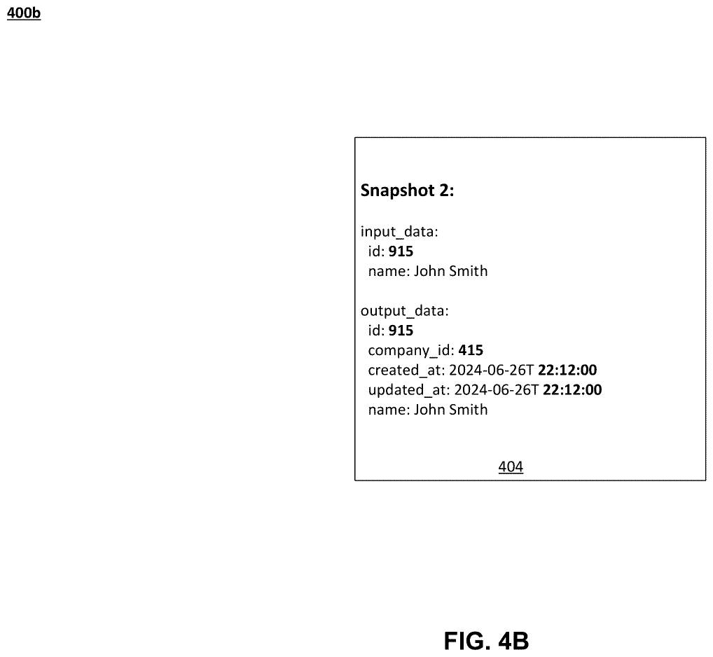

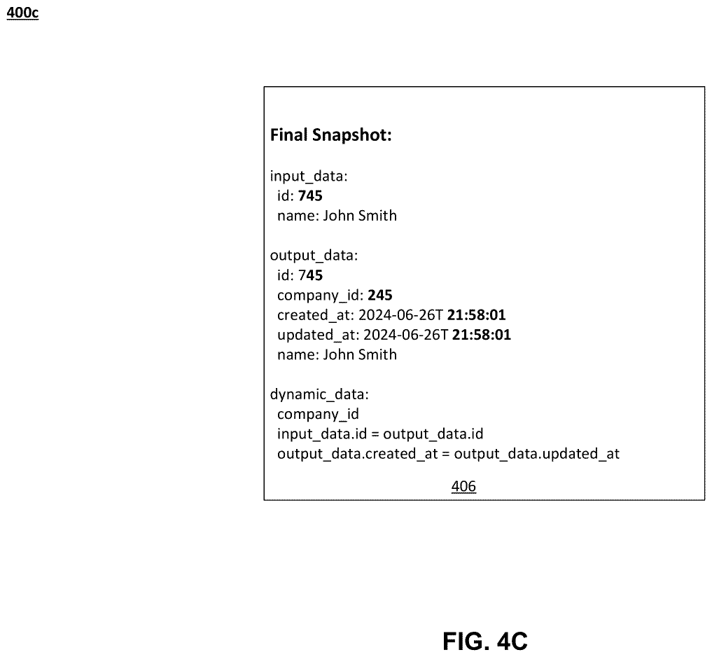

FIGS. 4A-4C are diagrams illustrating an example of a snapshot of three different runs of the same test according to aspects of the present disclosure. As shown in FIGS. 4A-4C, each test run may generate custom artifacts (e.g., name/ip of network, db name/address, etc.), which are subsequently saved into a snapshot (e.g., text file) in nested inheritance format.

As shown in example 400a of FIG. 4A, a first snapshot 402 may be generated after executing the software code with a generated test. The first snapshot shows that the input_data has an ID with a value of 745 and name of John Smith while the output_data has an ID with a value of 745, company_id of 245, date of creation, date of update, and the name John Smith.

As shown in example 400b of FIG. 4B, a second snapshot 404 may be generated after executing the software code a second time using the same generated test. The second snapshot shows that the input_data has an id value of 915 and name of John Smith while the output_data has an ID with a value of 915, company ID of 415, creation date, update date, and the name John Smith.

As shown in example 400c of FIG. 4C, a final snapshot 406 may be generated after executing the software code with the same generated test. The final snapshot 406 shows that the input_data has an ID with a value of 745 and a name of John Smith and the output_data has an id of 745, a company id of 245, creation date, update date, and the name John Smith. It should be noted that the values in the “output_data” section is the same as the “output_data” section shown in example 402 of FIG. 4A. In addition, using a trained machine learning module (e.g., neural network), the final snapshot 406 stores results from the analyzer module 114 indicating that the dynamic data is company ID, the input_data. id should equal the output_data. id, and that the output_data. created_at should equal the output_data. updated_at.

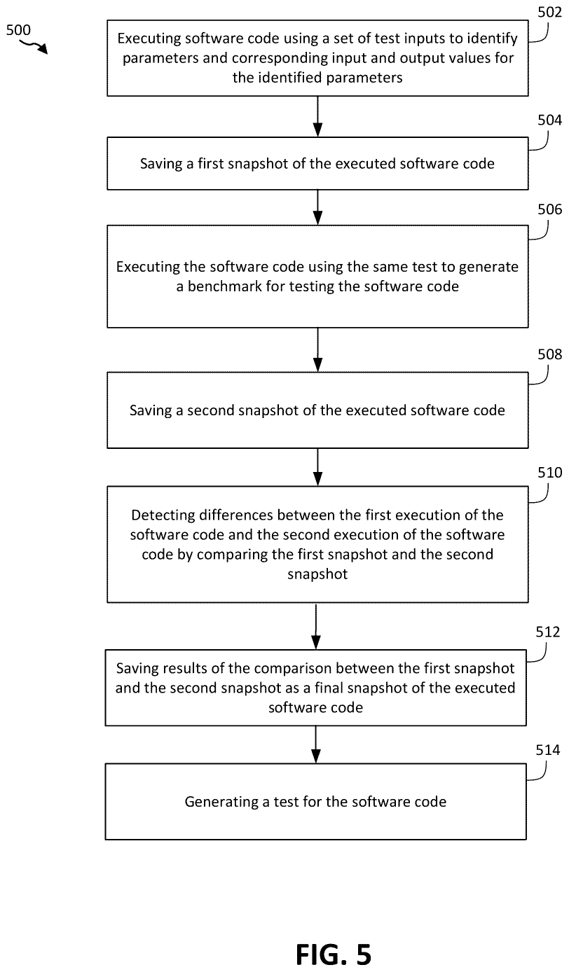

FIG. 5 is a flow diagram of method 500 for a snapshot-based testing of software code. In various implementations, the method 500 is performed by a device with one or more processors, a code execution module 108, a snapshot module 110, a comparison module 112, an analyzer module 114 including a machine learning module 115 (e.g., machine learning module 115 shown in FIG. 1), a test generation module 116, and a code management module 118. In some implementations, the method 500 is performed by processing logic, including hardware, firmware, software, or a combination thereof. In some implementations, the method 500 is performed by a processor executing code stored in a non-transitory computer-readable medium (e.g., a memory). Generally, the method 500 includes automatic validation of software code by applying a generated test to executed modified software code to identify errors in the modified software code using a first and second snapshot from previous executions of the software code.

Automatic validation ensures that test runs are consistently applied, reducing the risk of human error and increasing the reliability of test results. In addition, automated validation rules can quickly and efficiently check for issues, which saves time compared to manual testing. Automatically generating validation rules may cover a wide range of scenarios, ensuring that all aspects of the software are tested. Automated rules also reduce the risk of oversight, ensuring that tests are accurate and comprehensive. Automated validation rules also ensure that new changes do not break existing functionality to provide confidence in the stability of the software. Furthermore, automated validation rules can handle large codebases and complex systems, ensuring that all parts of the software are tested. Automated tests can also be easily scaled to cover new features and changes, ensuring that software remains robust as it evolves.

At 502, the method 500 may include executing software code using a set of test inputs to identify a plurality of input and output parameters and their corresponding input and output values for the identified input and output parameters. As an example, referring back to FIG. 1, the code execution module 108 may execute software code 102 using a set of test inputs from the rules database 124 in order to identify parameters and corresponding input and output values for the identified parameters.

At 504, the method 500 may include saving a first snapshot of the executed software code. As an example, referring back to FIG. 1, the snapshot module 110 may include saving a first snapshot of the executed software code.

At 506, the method 500 may include executing the software code using the same test to generate a benchmark for testing the software code. As an example, referring back to FIG. 1, the code execution module 108 may execute software code 102 using a same test to generate a benchmark for testing the software code 102.

At 508, the method 500 may include saving a second snapshot of the executed software code. As an example, referring back to FIG. 1, the snapshot module 110 may include saving a second snapshot of the executed software code.

At 510, the method 500 may include detecting differences between the first execution of the software code and the second execution of the software code by comparing the first snapshot and the second snapshot. As an example, referring back to FIG. 1, the comparison module 112 may include detecting differences between the first execution of the software code 102 and the second execution of the software code 102 by comparing the first snapshot and the second snapshot from the snapshot/parameter database 120. In some examples, the comparison module 112 may detect correlations between dynamic parameters from the snapshots using exact comparison, statistical correlation methods, or using neural networks from the machine learning module 115.

At 512, the method 500 may include saving results of the comparison between the first snapshot and the second snapshot as a final snapshot of the executed software code. As an example, referring back to FIG. 1, the snapshot module 110 may include saving a final snapshot of the executed software code.

At 514, the method 500 may include generating a test for the software code. As an example, referring back to FIG. 1, the test generation module 116 may include generating a test for the software code 102. The test may include a plurality of test rules comparing the values of static parameters and/or comparing the values of related dynamic parameters in each snapshot and/or between the first and second snapshots. In this way, the test may be applied to modified software code to compare, using the plurality of test rules, the input and output values of the static parameters or input and/or output values of the related dynamic parameters of the modified executed software code with values of the corresponding parameters of the first and second snapshots to identify errors in the modified executed software code.

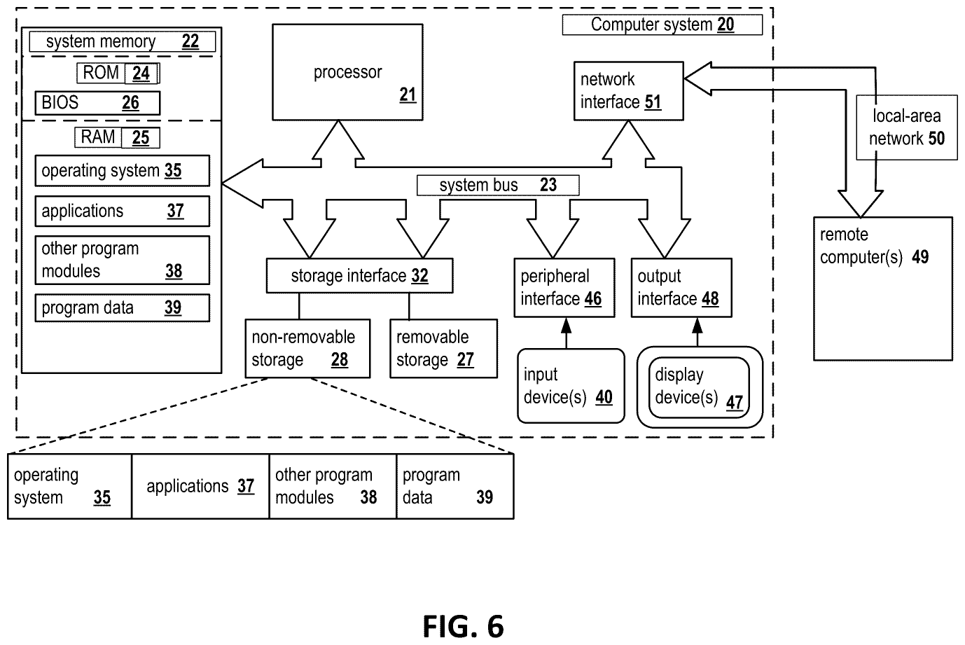

FIG. 6 is a block diagram illustrating a computer system 20 on which aspects of systems and methods for synchronizing race telemetry, video, and map data may be implemented. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-5 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for snapshot-based testing of software code, comprising:
receiving a first snapshot of an executed software code, wherein the first snapshot identifies a plurality of input and output parameters and corresponding values for each parameter;
receiving a second snapshot of the executed software code, wherein the second snapshot identifies a plurality of input and output parameters and corresponding values for each parameter;
comparing the first and second snapshots to identify static and/or dynamic parameters, wherein the static parameters have the same input and output values in both the first and second snapshots, and dynamic parameters have the same input values and different output values in each snapshot;
analyzing the executed software code to determine relationships between the dynamic parameters and to identify related dynamic parameters;
generating a test for testing the software code, wherein the test comprises a plurality of test rules comparing the values of static parameters and/or comparing the values of related dynamic parameters in each snapshot and/or between the first and second snapshots;
receiving a modification to the software code; and
applying the generated test to the executed modified software code to compare, using the plurality of test rules, the input and output values of the static parameters or input and/or output values of the related dynamic parameters of the modified executed software code with values of the corresponding parameters of the first and second snapshots to identify errors in the modified executed software code.

2. The method of claim 1, further comprising:
executing the software code on a set of input parameters to generate the first snapshot;
executing the software code on a similar test to generate the second snapshot, wherein the similar test corresponds to the generated test with a subset of new input parameters ; and
executing the modified executed software code on the same set of input parameters.

3. The method of claim 2, further comprising:
executing the software code on the same set of input parameters to generate the second snapshot.

4. The method of claim 1, wherein analyzing the executed software code further comprises using a trained ML model to determine relationships between the dynamic parameters and to identify related parameters.

5. The method of claim 4, further comprising:
executing the software code using the trained ML model to identify the plurality of parameters and the corresponding input and output values for each parameter.

6. The method of claim 4, wherein comparing the first and second snapshots further comprises:
executing the software code using the trained ML model to identify relationships between the related dynamic parameters.

7. The method of claim 4, further comprising:
training the ML model using training datasets comprising snapshots from other tests of the same executed software code to determine relationships between the dynamic parameters and to identify related dynamic parameters.

8. The method of claim 1, wherein the plurality of test rules comprises at least one of:
determining whether a value exists for each static parameter or each related dynamic parameter,
determining a value type for each static parameter or each related dynamic parameter,
determining static values for each static parameters, or
determining relationship for each dynamic parameter.

9. The method of claim 1, further comprising:
storing the input and output values of the static parameters or input and/or output values of the related dynamic parameters of the modified executed software code with values of the corresponding parameters of the first and second snapshots as a final snapshot.

10. The method of claim 9, further comprising:
receiving a new snapshot of the modified executed software code, wherein the new snapshot identifies a plurality of parameters and corresponding input and output values for each parameter; and
based on a determination that the identified parameters are static parameters, comparing, using the plurality of test rules, the input and/or output values of the static parameters of the modified executed software code with values of the corresponding parameters of the final snapshot to identify errors in the modified executed software code.

11. The method of claim 9, further comprising:
receiving a new snapshot of the modified executed software code, wherein the new snapshot identifies a plurality of parameters and corresponding input and output values for each parameter; and
based on a determination that the identified parameters are dynamic parameters, comparing, using the plurality of test rules, the output values of the related dynamic parameters of the modified executed software code with values of the corresponding parameters of the final snapshot to identify errors in the modified executed software code.

12. The method of claim 1, wherein the static and dynamic parameters correspond to at least one of variables, functions, form fields, or file paths.

13. A system for snapshot-based testing of software code, the system comprising:
at least one memory; and
at least one hardware processor coupled with the at least one memory and configured, individually or in combination, to:
receive a first snapshot of an executed software code, wherein the first snapshot identifies a plurality of input and output parameters and their corresponding values;
receive a second snapshot of the executed software code, wherein the second snapshot includes a plurality of parameters and corresponding input and output values for each parameter;
compare the first and second snapshots to identify static and/or dynamic parameters, wherein the static parameters have the same input and output values in both the first and second snapshots, and dynamic parameters have the same input values and different output values in each snapshot;
analyze the executed software code to determine relationships between the dynamic parameters and to identify related dynamic parameters;
generate a test for testing the software code, wherein the test comprises a plurality of test rules comparing the values of static parameters and/or comparing the values of related dynamic parameters in each snapshot and/or between the first and second snapshots;
receive a modification to the software code; and
apply the generated test to the executed modified software code to compare, using the plurality of test rules, the input and output values of the static parameters or input and/or output values of the related dynamic parameters of the modified executed software code with values of the corresponding parameters of the first and second snapshots to identify errors in the modified executed software code.

14. The system of claim 13, wherein the least one hardware processor coupled with the at least one memory is further configured, individually or in combination, to:
execute the software code on a set of input parameters to generate the first snapshot;
execute the software code on the same test to generate the second snapshot; and
execute the modified executed software code on the same set of input parameters.

15. The system of claim 14, wherein the least one hardware processor coupled with the at least one memory is further configured, individually or in combination, to:
execute the software code on the same set of input parameters to generate the second snapshot.

16. The system of claim 13, wherein analyzing the executed software code further comprises using a trained ML model to determine relationships between the dynamic parameters and to identify related parameters.

17. The system of claim 16, wherein the least one hardware processor coupled with the at least one memory is further configured, individually or in combination, to:
execute the software code using the trained ML model to identify the plurality of parameters and the corresponding input and output values for each parameter.

18. The system of claim 16, wherein comparing the first and second snapshots further comprises:
executing the software code using the trained ML model to identify relationships between the related dynamic parameters.

19. The system of claim 16, wherein the least one hardware processor coupled with the at least one memory is further configured, individually or in combination, to:
train the ML model using training datasets comprising snapshots from other tests of the same executed software code to determine relationships between the dynamic parameters and to identify related dynamic parameters.

20. A non-transitory computer readable medium storing thereon computer executable instructions for providing a secure large language model (LLM) deployment in an enterprise, including instructions for:
receiving a first snapshot of an executed software code, wherein the first snapshot identifies a plurality of input and output parameters and corresponding values for the input and output parameters;
receiving a second snapshot of the executed software code, wherein the second snapshot includes a plurality of input and output parameters and corresponding values for each parameter;
comparing the first and second snapshots to identify static and/or dynamic parameters, wherein the static parameters have the same input and output values in both the first and second snapshots, and dynamic parameters have the same input values and different output values in each snapshot;
analyzing the executed software code to determine relationships between the dynamic parameters and to identify related dynamic parameters;
generating a test for testing the software code, wherein the test comprises a plurality of test rules comparing the values of static parameters and/or comparing the values of related dynamic parameters in each snapshot and/or between the first and second snapshots;
receiving a modification to the software code; and
applying the generated test to the executed modified software code to compare, using the plurality of test rules, the input and output values of the static parameters or input and/or output values of the related dynamic parameters of the modified executed software code with values of the corresponding parameters of the first and second snapshots to identify errors in the modified executed software code.
